(19) United States
(12) Patent Application Publication
(10) Pub. No.: US 2025/0217188 A1
(43) Pub. Date: Jul. 3, 2025

(54) METHOD AND APPARATUS FOR OPTIMISING USAGE OF A PROCESSING UNIT FOR EXECUTING MACHINE LEARNING MODELS

(71) Applicant: Samsung Electronics Co., Ltd., Suwon-si (KR)

(72) Inventors: Alexandros KOURIS, Chertsey (GB); Stylianos VENIERIS, Chertsey (GB); Stefanos LASKARIDIS, Chertsey (GB)

(21) Appl. No.: 19/084,057

(22) Filed: Mar. 19, 2025

Related U.S. Application Data
(63) Continuation of application No. PCT/KR2023/014650, filed on Sep. 25, 2023.

(30) Foreign Application Priority Data
Sep. 23, 2022 (GR) 20220100785
Sep. 21, 2023 (GB) 2314461.1

(51) Int. Cl. G06F 9/48; G06N 3/04

(52) U.S. Cl. CPC G06F 9/4881; G06N 3/04; G06F 2209/485

(57) ABSTRACT

An embodiment of the disclosure provides a method for optimising usage of a processing unit that is used to execute machine learning, ML, models. In particular, the present disclosure provides an apparatus and method for processing data using a multi-exit ML model in a way that optimises the usage of a processing unit used to execute the model.

### CROSS-REFERENCE TO RELATED APPLICATION(S)

This application is a continuation application, claiming priority under 35 U.S.C. § 365(c), of an International application No. PCT/KR2023/014650, filed on Sep. 25, 2023, which is based on and claims the benefit of a Greek patent application No. 20220100785, filed on Sep. 23, 2022, in the Greek Intellectual Property Office, and of a United Kingdom patent application number 2314461.1, filed on Sep. 21, 2023, in the United Kingdom Intellectual Property Office, the disclosure of each of which is incorporated by reference herein in its entirety.

### TECHNICAL FIELD

The present disclosure generally relates to a method and an apparatus for optimising usage of a processing unit that is used to execute machine learning, ML, models. In particular, the present disclosure provides an apparatus and method for processing data using a multi-exit ML model in a way that optimises the usage of a processing unit used to execute the model.

### BACKGROUND ART

The continued advancement of deep neural networks, DNNs, has led to their mainstream adoption in consumer applications, as a backbone for several computer vision tasks. This has led to the formation of smart ecosystems within the consumer environment, where plentiful neighbouring devices are simultaneously collecting an abundance of data. The high concentration of sensing platforms in such local ecosystems has shifted the inference paradigm one step away from the device, at the edge, where data from several sources can be streamed to a more powerful shared compute platform for inference. Smart homes and mobile robots constitute prime examples of this scenario, as in both cases several visual sensors are continuously capturing images that often need to be processed by the same model (e.g. person identification) under strict latency constraints.

This increased rate of DNN inference requests on the same model from multiple sources, unlocks the potential of batch processing that constitutes a promising approach for meeting the throughput demand with a given neural processing unit (NPU) at the edge. By grouping samples and dispatching them together to the NPU, parallelism and data-reuse are increased, leading to improved hardware utilisation, higher processing rate and potentially shorter waiting time for incoming samples. However, batching comes at a cost; the time overhead of assembling samples and the longer computation time induces increased latency which can impact the quality of experience (QoE). As such, the status-quo wisdom dictates that batch processing should be avoided in latency-critical applications. In this context, there is an emerging need for novel methods that leverage the throughput benefits of batching to serve a multitude of inference requests while also meeting tight latency constraints so that the QoE is not penalised.

However, the inherent dynamicity of smart ecosystems and user behaviour leads to varying inference request rates. For example, the dynamic adjustment of sampling rates-commonly used to reduce computational load and energy consumption-affects batch formation at the edge NPU where all samples are streamed. This calls for new hardware solutions that enable the NPU to sustain high performance across variable batch sizes. At the same time, a growing body of work is developing multi-exit DNNs. This family of dynamic models attaches intermediate exits throughout the architecture and saves computation by allowing easier samples to exit early. Despite the latency benefits, this mechanism introduces further dynamicity to the batch size, at a subnet level; as samples may exit early at intermediate exits, the batch size shrinks dynamically during inference. This leads to hardware underutilisation for deeper parts of the model and an inefficient use of the NPU, requiring a novel system design approach.

The applicant has therefore identified the need for an improved way to optimise usage of processing units when executing a multi-exit machine learning model.

### DISCLOSURE

### Technical Solution

In an embodiment of the disclosure, there is provided an apparatus for processing data using a multi-exit machine learning, ML, model having a plurality of neural network layers, and a plurality of early exits and a final exit to provide predictions, the apparatus comprising: at least one processor coupled to memory, for: receiving a data stream, the data stream comprising a plurality of data items to be processed by the multi-exit ML model; and forming, using a scheduler, an active data batch for processing by the multi-exit ML model, using at least one data item from the plurality of data items in the data stream; and a processing unit, PU, for executing the multi-exit ML model by: receiving, from the at least one processor, the active data batch for processing by the multi-exit ML model; processing the active data batch until a pre-emption point, the pre-emption point being an early exit of the plurality of early exits; outputting a prediction for one or more data items in the active data batch at the pre-emption point; pausing processing of the active data batch; transmitting, to the scheduler, information about the one or more data items in the active data batch for which a prediction has been output from the pre-emption point; receiving, via the scheduler, a new active data batch for processing up until the pre-emption point, the new active data batch containing at least one data item from the data stream that is different to the at least one data item in the active data batch; processing the new active data batch until the pre-emption point; combining the active data batch with the new active data batch to form a merged active data batch; and processing the merged active data batch until a subsequent pre-emption point or to the final exit of the multi-exit ML model.

The apparatus enables data items to be processed by the multi-exit ML model in batches. The multi-exit ML model processes one batch at a time, where the batch is referred to herein as an “active data batch”. The active data batch has a maximum size, which is fixed for the ML model, i.e. is the same for all layers of the ML model. The active data batch contains at least one data item. In some cases, the active data batch may contain a single data item, because, for example, the single data item is of a size substantially similar to the maximum size of the active data batch, or because there is no other data item to be processed.

An advantage of an embodiment is that data items can be added to the active data batch after processing of the active data batch has begun. Specifically, because the active data batch is being processed using a multi-exit ML model, predictions for one or more data items in the active data batch may be output at an early exit of the ML model. Once the prediction has been output for a data item, it no longer needs to be processed by the ML model, which means the size of the active data batch has reduced. Any data items remaining in the active data batch need to be processed further by the ML model, but the processing unit, PU, will be underutilised when processing the remaining data items because it is able to process a larger batch. An embodiment enables a larger batch to be created so that the usage of the PU is maximised. As noted above, this occurs by pausing processing of the active data batch at the point at which the prediction(s) has been output (i.e. the pre-emption point), beginning processing of a new active data batch up to that point, and then merging the data items from the paused active data batch and the data items from (or remaining within) the new active data batch. The merged data items, referred to as the merged active data batch, is now processed by the PU from the pre-emption point onwards. (At any given time, the ML model is processing a single active data batch.) The merged active data batch is processed until either the final exit of the multi-exit ML model, or to a subsequent/next pre-emption point. As explained below in more detail, the multi-exit ML model may comprise a pre-emption point at one or more of the early exits of the multi-exit ML model. An embodiment allows pre-emption to occur only at early-exit points. Thus, in some cases, the merged active data batch may be processed until a subsequent pre-emption point when such a pre-emption point exists. At this stage, the processing of the merged active data batch may be paused here to enable generation of a larger active data batch again.

An embodiment of the disclosure are advantageous because in early-exit models, a prediction may be provided for a particular data item from an early exit which means that no further processing is required in relation to that particular data item. This in turn means that the processing unit, PU, has capacity to process another data item in addition to any data items for which no early-exit prediction has been made. The batching and pre-emption of an embodiment enable optimised usage of the hardware/PU.

At a pre-emption point, the size of the active data batch may be the same as the size at the start of the processing by the multi-exit ML model (if no prediction for a data item has been output by this point), or may have decreased (if a prediction for a data item(s) has been output by this point). At the pre-emption point, the scheduler makes a decision on whether new samples from the data stream will be fetched to form a new active data batch, which will then be independently processed up to the same pre-emption point. In some cases, the scheduler may decide that no new active data batch is to be formed. This may be, for example, if a latency requirement for the processing of one or more data items in the (current, paused) active data batch will be violated, or because no predictions have yet been output for the active data batch, such that the size of the active data batch has not changed. In such cases, processing of the (current, paused) active data batch is resumed. In other cases, the scheduler decides that a new active data batch is to be formed. In such cases, the new active data batch contains at least one data item from the data stream that is different to the at least one remaining data item in the active data batch (of which processing has paused temporarily). In other words, the new active data batch is formed using one or more data items from the data stream that are not already in the active data batch. The one or more data items for the new active data batch may be fetched based on a queue order of the data items in the data stream. That is, the data items are added to the active data batches based on their place in a queue, which is based on when the data items were received in the data stream. However, predictions may be output for data items in a different order, because predictions for data items may be output from any exit (early or final) of the ML model.

The scheduler may be implemented as software. In this case, the scheduler may be an algorithm executed by the at least one processor (e.g. a CPU).

The scheduler may be implemented as hardware. In this case, the apparatus may comprise a processing chip, and the scheduler is a module on the processing chip. The processing chip may comprise other modules, such as, for example, the proposed Fluid Batching Control Block and off-chip memory described in more detail below with respect to the Figures. The at least one processor (e.g. CPU) may form the active data batch by instructing the external scheduler to do so.

The scheduler may form the active data batch by selecting at least one data item from the data stream to form the active data batch, based on an order of the data items in the data stream and a maximum active batch size. Data items may be received via the data stream in a sequence. The data items may be received periodically or at irregular frequencies/times. The data items are added to the active data batch based on the order in which the data items are received. It should be noted that predictions for the data items in an active data batch may not be output in the same order, because predictions for some data items may be output at an earlier exit of the ML model than others.

The scheduler may determine the maximum active batch size using a latency constraint. The latency constraint specifies a time in which a prediction for a data item needs to be provided, assuming that a prediction for a data item is output by the final exit of the ML model.

The scheduler may determine the maximum active batch size using a processing capability of the processing unit, PU. As explained in more detail below, a maximum active batch size may be determined in advance based on experiments to optimise batch size for different PU types.

As explained in more detail below, existing techniques assemble batches of data items by appending data items (or activation matrices thereof) along a single dimension of a matrix for all layers of a ML model. However, different parts of an ML model may benefit from different batch configurations. For example, while assembling batches of data items along one or more rows of a matrix may be suitable for one layer, another layer may benefit from the data items being assembled along one or more columns, and another layer may benefit from the data items being assembled along one or more columns and one or more rows of a matrix. Advantageously, an embodiment of the disclosure enables dynamic and flexible assembly of data items based on the layer of the multi-exit ML model that is being executed/run.

Thus, the apparatus may further comprise a batching engine for controlling the processing unit, PU. The batching engine may be hardware-based or implemented using software. In any case, the batching engine may be configured to: determine the size of the active data batch; obtain, from a look-up table, an optimum batching configuration for each layer of the multi-exit ML model as a function of the determined size of the active data batch; and instruct, prior to processing by a layer of the multi-exit ML model, the processing unit, PU, to assemble the selected at least one data item using the obtained optimum batching configuration for the layer.

The active data batch may be formed by assembling the data items (or values associated with the data items or values of intermediate processing results for the data items) into a matrix having a number of rows and a number of columns. Before each layer of the ML model is executed, the processing unit, PU, may assemble the active data batch according to a configuration required/best suited to that layer. Thus, the processing unit, PU, may be configured to: receive the instructions from the batching engine; and assemble, prior to processing by a layer of the multi-exit ML model, the selected at least one data item in the active data batch using the obtained optimum batching configuration for the layer by: assembling the selected at least one data item along one or more rows, or assembling the selected at least one data item along one or more columns, or assembling the selected at least one data item across at least one row and at least one column.

The batching engine may comprise: a control block comprising the look-up table; and a control unit for: tracking the determined active data batch size, determining which layer of the multi-exit ML model is to be used next to process the active data batch, using the determined active data batch size and determined layer of the multi-exit ML model to obtain the optimum batching configuration for the determined layer, and instructing the processing unit, PU, to assemble the active data batch using the optimum batching configuration for the determined layer.

When the processing unit pauses processing of the active data batch, the processing unit may be arranged to: write, to an off-chip memory, an intermediate processing result for any remaining data items in the active data batch. This allows the new active data batch to be processed, up to the pre-emption point, while maintaining information about the processing already performed for the (previous) active data batch.

An intermediate processing result for the active data batch may be written to off-chip memory whenever execution of a layer of the ML model has been completed, so that any required configuration of the active data batch may be performed.

When the new active data batch has been processed up to the pre-emption point, prior to any further processing by a next layer of the multi-exit ML model, the processing unit combines the active data batch with the new active data batch. The combining may comprise: reading the intermediate processing result for the active data batch from the off-chip memory; and merging the read intermediate processing result with a new intermediate processing result for the new active data batch.

The multi-exit ML model may comprise a pre-emption point at a plurality of the early exits of the multi-exit ML model. In other words, for an L-layer ML model with a plurality of early exits, the pre-emption points may be at each early exit or only some (or even only one) of the early exits. An embodiment of the disclosure allows pre-emption to occur only at early-exit points. This is advantageous because it is much more efficient than if pre-emption could occur at every layer L—in the latter case, the scheduler would be invoked too regularly, leading to an increase in computations and interruptions of the PU.

When a prediction has been output for one or more data items in the active data batch, it is necessary to determine how to generate the new active data batch which will be processed up to the pre-emption point and then merged with the (current, paused) active data batch. This determination depends on a number of factors, including the size of the (current, paused) active data batch now that one or more predictions have been output. Thus, the at least one processor may be configured to: receive, from the processing unit, information about the one or more data items in the active data batch for which a prediction has been output from the pre-emption point; calculate, using the scheduler, a size of any data items remaining in the active data batch for which no prediction has been output; and determine, using the calculated size and the scheduler, a size for the new active data batch.

The at least one processor may then estimate, using the scheduler, a completion time for processing an oldest data item of the data items remaining in the active data batch for which no prediction has been output, the completion time including an elapsed time taken to reach the pre-emption point. That is, in the current, now paused active data batch, it is necessary to estimate a total time for a prediction to be output for the oldest data item in the data batch, assuming a prediction may be output at the final exit of the ML model. The actual total time may be lower than the estimate if a prediction is output at an early exit. The estimated total time is determined to ensure that if pre-emption is used to generate a new active data batch, any latency criterion is not violated.

Thus, the at least one processor may: determine, using the scheduler, whether the estimated completion time for processing the oldest data item in the active data batch is less than a predefined latency constraint; and form, using the scheduler and the determined size for the new active data batch, the new active data batch using one or more data items from the data stream, when the estimated completion time is determined to be less than the predefined latency constraint.

The at least one processor may: determine, using the scheduler, whether the estimated completion time for processing the oldest data item in the active data batch is less than a predefined latency constraint; and instruct the processing unit, PU, to continue processing the (currently paused) active data batch when the estimated completion time is determined to be greater than or equal to the predefined latency constraint. In this case, the new active data batch is not formed because doing so would cause the latency constraint to be violated.

The processing unit, PU, which executes the multi-exit ML model may be a central processing unit, CPU, graphics processing unit, GPU, or neural processing unit, NPU.

In an embodiment of the disclosure, there is provided a method for processing data using a multi-exit machine learning, ML, model having a plurality of neural network layers, and a plurality of early exits and a final exit to provide predictions, the method comprising: receiving a data stream, the data stream comprising a plurality of data items to be processed by the multi-exit ML model; forming an active data batch for processing by the multi-exit ML model, using at least one data item from the plurality of data items in the data stream; processing the active data batch using the multi-exit ML model until a pre-emption point, the pre-emption point being an early exit of the plurality of early exits; outputting a prediction for one or more data items in the active data batch at the pre-emption point; pausing processing of the active data batch; determining, using information about the one or more data items in the active data batch for which a prediction has been output from the pre-emption point, a new active data batch for processing up until the pre-emption point, the new active data batch containing at least one data item from the data stream that is different to the at least one data item in the active data batch; processing the new active data batch using the multi-exit ML model until the pre-emption point; combining, when the pre-emption point is reached, the active data batch with the new active data batch to form a merged active data batch; and processing the merged active data batch using the multi-exit ML model until a subsequent pre-emption point or to the final exit of the multi-exit ML model. Steps of the method may be performed using software or hardware, or a combination of software and hardware.

The method may further comprise: selecting at least one data item from the data stream to form the active data batch, based on an order of the data items in the data stream and a maximum active batch size.

The method may further comprise: determining the maximum active batch size using a latency constraint and/or a processing capability of a processing unit, PU, used to execute the multi-exit ML model.

The method may further comprise: determining the size of the active data batch; obtaining, from a look-up table, an optimum batching configuration for each layer of the multi-exit ML model as a function of the determined size of the active data batch; and assembling, prior to processing by a layer of the multi-exit ML model, the selected at least one data item using the obtained optimum batching configuration for the layer.

When processing of the active data batch is paused, the method may comprise: writing, to an off-chip memory, an intermediate processing result for any remaining data items in the active data batch.

Combining the active data batch with the new active data batch may further comprise: reading the intermediate processing result from the off-chip memory; and merging the read intermediate processing result with a new intermediate processing result for the new active data batch.

The method may further comprise: receiving information about the one or more data items in the active data batch for which a prediction has been output from the pre-emption point; calculating, using the scheduler, a size of any data items remaining in the active data batch for which no prediction has been output; determining, using the calculated size and the scheduler, a size for the new active data batch; and estimating, using the scheduler, a completion time for processing an oldest data item of the data items remaining in the active data batch for which no prediction has been output, the completion time including an elapsed time taken to reach the pre-emption point.

The method may further comprise: determining, using the scheduler, whether the estimated completion time for processing the oldest data item in the active data batch is less than a predefined latency constraint; and forming, using the scheduler and the determined size for the new active data batch, the new active data batch using one or more data items from the data stream, when the estimated completion time is determined to be less than the predefined latency constraint; or continuing processing the active data batch when the estimated completion time is determined to be greater than or equal to the predefined latency constraint.

In an embodiment of the disclosure, there is provided a processing unit, PU, for processing data using a multi-exit machine learning, ML, model having a plurality of neural network layers and a plurality of early exits and a final exit to provide predictions, the processing unit executing the ML model by: receiving, from a scheduler, an active data batch for processing; processing the active data batch until a pre-emption point, the pre-emption point being an early exit of the plurality of early exits; outputting a prediction for one or more data items in the active data batch at the pre-emption point; pausing processing of the active data batch; transmitting, to a scheduler, information about the one or more data items in the active data batch for which a prediction has been output from the pre-emption point; receiving, via the scheduler, a new active data batch for processing up until the pre-emption point, the new active data batch containing at least one data item from the data stream that is different to the at least one data item in the active data batch; processing the new active data batch until the pre-emption point; combining the active data batch with the new active data batch to form a merged active data batch, and processing the merged active data batch until a subsequent pre-emption point or to the final exit of the multi-exit ML model.

Features described above with respect to the processing unit for the embodiment corresponding to the apparatus or the method apply equally to the embodiment corresponding to the above processing unit and, for the sake of conciseness are not repeated.

In an embodiment of the disclosure, there is provided a computer-readable storage medium comprising instructions which, when executed by a processor, causes the processor to carry out any of the methods described herein.

As will be appreciated by one skilled in the art, an embodiment of the disclosure may be embodied as a system, method or computer program product. Accordingly, an embodiment of the disclosure may take the form of an entirely hardware embodiment, an entirely software embodiment, or an embodiment combining software and hardware aspects.

Furthermore, an embodiment of the disclosure may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of an embodiment of the disclosure may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

An embodiment of the disclosure also provides a non-transitory data carrier carrying code which, when implemented on a processor, causes the processor to carry out any of the methods described herein.

An embodiment of the disclosure further provides processor control code to implement the above-described methods, for example on a general purpose computer system or on a digital signal processor (DSP). An embodiment of the disclosure also provides a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement an embodiment of the disclosure described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. An embodiment of the disclosure may comprise a controller which includes a microprocessor, working memory and program memory coupled to one or more of the components of the system.

It will also be clear to one of skill in the art that all or part of a logical method according to an embodiment of the present disclosure may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

An embodiment of the disclosure may be realised in the form of a data carrier having functional data thereon, said functional data comprising functional computer data structures to, when loaded into a computer system or network and operated upon thereby, enable said computer system to perform all the steps of the above-described method.

The method described above may be wholly or partly performed on an apparatus, i.e. an electronic device, using a machine learning or artificial intelligence model. The model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

As mentioned above, an embodiment of the disclosure may be implemented using an AI model. A function associated with AI may be performed through the non-volatile memory, the volatile memory, and the processor. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm to a plurality of learning data, a predefined operating rule or AI model of a desired characteristic is made. The learning may be performed in a device itself in which AI according to an embodiment is performed, and/o may be implemented through a separate server/system.

The AI model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

### DESCRIPTION OF DRAWINGS

Implementations of the present disclosure will now be described, by way of example only, with reference to the accompanying drawings, in which:

FIG. 1 is a graph showing impact of early exits on hardware utilisation with batch processing across two FPGA platforms and a graph showing achieved throughput with different batching strategies;

FIG. 2 is a schematic diagram showing the computation of a convolutional layer, mapped as GEMM;

FIG. 3 is a schematic diagram according to an embodiment of the present disclosure;

FIG. 4 shows an input matrix formation with different batching strategies (here B=4), and how this relates to an NPU architecture;

FIG. 5 shows a hardware microarchitecture design of the present Fluid Batching Engine;

FIG. 6 illustrates the operation of the present scheduler;

FIG. 7 shows Algorithm 1, which details the present scheduling method;

FIG. 8 is a schematic diagram of the fluid batching approach according to an embodiment of the present disclosure;

FIGS. 9 and 10 show results of experiments to evaluate performance according to an embodiment of the present disclosure;

FIG. 11 show results of experiments to assess robustness of an embodiment of the present disclosure to different latency SLOs;

FIG. 12 show results of experiments to compare an embodiment of the present disclosure with status-quo batching techniques;

FIGS. 13 to 15 are diagrams illustrating example uses according to an embodiment of the present disclosure;

FIG. 16 is a flowchart of example steps of a method for processing data using a multi-exit machine learning model having a plurality of neural network layers, a plurality of early exits and a final exit to provide predictions; and

FIG. 17 is a block diagram of an apparatus for processing data using a multi-exit machine learning model.

### MODE FOR INVENTION

An embodiment of the disclosure provides a method for optimising usage of a processing unit that is used to execute machine learning, ML, models. In particular, the present application provides an apparatus and method for processing data using a multi-exit ML model in a way that optimises the usage of a processing unit used to execute the model.

As mentioned above, in modern neural processing units, NPUs, all layers of a DNN are sequentially scheduled on the accelerator. However, not all layers perfectly fit the fixed hardware configuration of the NPU. As a result, variable hardware (under-) utilisation is observed across different parts of the network. Batching has been traditionally used to alleviate this inefficiency by increasing the parallelism of a layer, improving throughput at the expense of a controlled latency overhead. In conventional DNNs, the whole network is executed with the specified batch size. In the case of multi-exit models, samples within a batch can early-exit in earlier parts of the network, resulting in variable batch sizes across different layers of the model.

With deep neural networks (DNNs) emerging as the backbone in a multitude of computer vision tasks, their adoption in real-world applications broadens continuously. Given the abundance and omnipresence of smart devices in the consumer landscape, “smart ecosystems” are being formed where sensing happens concurrently rather than standalone. This is shifting the on-device inference paradigm towards deploying centralised neural processing units (NPUs) at the edge, where multiple devices (e.g. in smart homes or autonomous vehicles) can stream their data for processing with dynamic rates. While this provides enhanced potential for input batching, naive solutions can lead to subpar performance and quality of experience, especially under spiking loads. At the same time, the deployment of dynamic DNNs, comprising stochastic computation graphs (e.g. early-exit (EE) models), introduces a new dimension of dynamic behaviour in such systems.

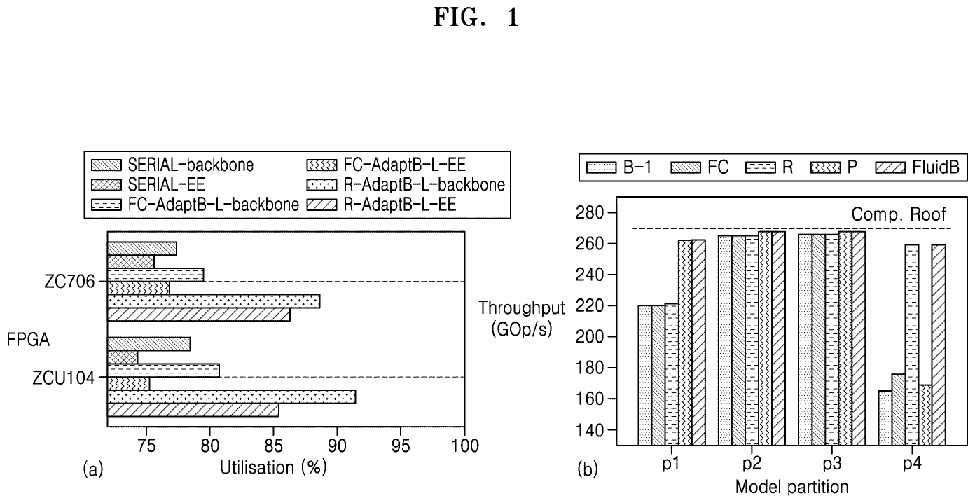

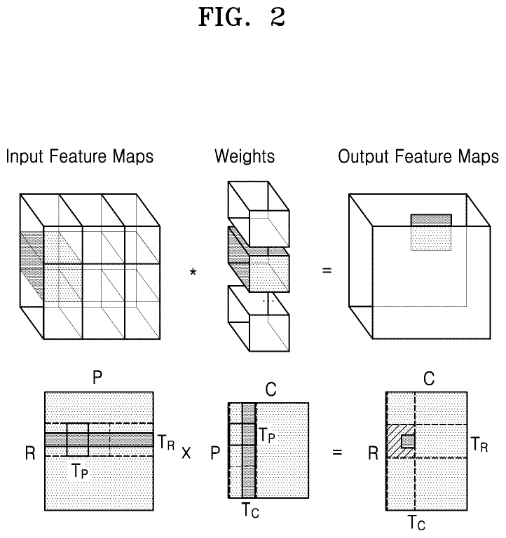

As mentioned above, multi-exit DNNs have latency benefits, but can lead to hardware underutilisation for deeper parts of the model and an inefficient use of the NPU. FIG. 1 (a) is a graph showing impact of early exits on hardware utilisation with batch processing across two FPGA platforms. The experiments on hardware utilisation looked at different batching strategies applied on a mainstream NPU design (N. P. Jouppi et al) that maps each convolution to a General Matrix Multiply operation, where inputs, weights and output activations are represented by RXP, P XC and RXC Toeplitz matrices (see FIG. 2), respectively, assuming a batch of B samples: SERIAL: B=1 | FC: Batching only on FC layers | R/P: Appending samples across the row/col dimension of the activation matrices. FIG. 1 (a) shows the impact of early exits (EE) on hardware utilisation with batch processing across two FPGA platforms, targeting a 4-exit ResNet-50 at an arrival rate of 25 samples/s. Although batching significantly improves the device utilisation for the original network, the stochasticity introduced by early exits radically attenuates this gain. Batches are formed using adaptive batching (AdaptB).

An embodiment of the present disclosure provides a novel early-exit aware scheduling algorithm that allows sample pre-emption at run time, to account for the dynamicity introduced both by the arrival and early exiting processes. At the same time, a novel dimension is introduced to the design space of the NPU hardware architecture, namely Fluid Batching, that enables run-time adaptability to different batch sizes and significantly improve the NPU utilisation even at small batches.

In order to deal with the enhanced dynamicity evident in the deployment of early-exit DNNs in streaming scenarios, based on the above-mentioned observations, an embodiment of the present disclosure provides a novel SW/HW co-design framework for edge NPU-based serving that employs two core techniques: i) Fluid Batching, a hardware-based mechanism that finely adapts the batching strategy based on both the instantaneous batch size and the characteristics of each layer, attaining high performance on the NPU across batch sizes; ii) an exit- and deadline-aware preemptive scheduler that allows the preemption of processing at intermediate exit points and the subsequent merging into larger batches, alleviating the NPU under-utilisation due to the reduced batch size in deeper parts of early-exit models.

Before explaining an embodiment of the present disclosure in more detail, some information about batch processing, early-exit ML models, and NPU architecture design is provided.

Batch processing has been adopted as a key technique towards increasing the inference throughput. Nonetheless, contrary to the training stage, forming batched inputs during inference is challenging as the processing platform receives DNN inference requests at rates that vary significantly based on the time of day and the number of applications or users that share the same model. Importantly, waiting to form a large-enough batch often has a prohibitive impact on latency. Existing batching approaches commonly integrate two techniques, i) model-level and ii) adaptive batching. Model-level batching dictates that batching is performed at the entire model granularity, i.e. the same batch size B is used for all layers of the DNN. Adaptive batching (AdaptB), which is employed by modern inference systems to adapt the batch size to the changing arrival rate, introduces another parameter, the batch-forming timeout window Tₜᵢₘₑₒᵤₜ, resulting in the batching strategy <Bₘₐₓ, Tₜᵢₘₑₒᵤₜ>. Concretely, AdaptB dispatches incomplete batches when Tₜᵢₘₑₒᵤₜ is exceeded, otherwise it issues the platform- or model-dependent maximum batch size Bₘₐₓ. Other techniques allow the selective preemption of inference at the layer level. Nonetheless, the use of a coarse latency estimator, together with its exit-unaware design, lead to conservative batching decisions, leaving untapped optimisation opportunities.

Contrary to their cloud-residing counterparts, edge-based inference systems are constrained in three ways: 1) edge NPUs have lower resource and energy budget and hence provide lower processing throughput. Thus, in spite of any throughput benefits, the large batch sizes that are common on the cloud (e.g. typically >8 and up to 64) directly violate the latency service-level objective (SLO) of interactive applications when executing high-accuracy—but costly—models; 2) the number of served devices—and in turn the queries per second—is one to two orders of magnitude lower (e.g. 102-103 queries/s on the cloud vs. tens on the edge). Forming large batch sizes would require prohibitive long waiting times to assemble enough samples; 3) although lightweight models could be employed to increase throughput, this would degrade the accuracy of the target task and would defeat the purpose of using a server. “Fluid Batching” alleviates these constraints by maximising the performance even at smaller batch size and dynamically filling gaps in the active batch as old samples early-exit and new ones arrive.

From a hardware perspective, existing NPU designs adopt a uniform solution for implementing batching across all layers, which can lead to suboptimal mapping and underutilisation in certain layers. Instead, Fluid Batching introduces a flexible mechanism that adapts the batching strategy on-the-fly at a per-layer basis to maximise resource utilisation and, thus, inference efficiency.

Dynamic DNNs come in many shapes and forms. A successful variant of such networks comes in the form of early-exit networks, DNNs with intermediate heads where samples can “exit early” based on shallow (and more coarse) features of the original network—the backbone. This mechanism yields computation savings due to the early termination of inference, while also providing early actionable results during inference and allowing for the progressive refinement of the output prediction. Early-exit networks have successfully been deployed in a multitude of tasks, spanning from image classification to semantic segmentation or even various NLP tasks. On the system side, existing work has so far focused on the hardware-aware design of the exit policy, and the placement and architecture of the exits along the depth of the backbone network, the distributed execution of such models across device and server, with some works also studying the implications of their deployment in streaming scenarios, and the co-design of an early-exit model and its hardware accelerator.

Existing works, however, have focused on single-sample execution and do not consider the hardware utilisation impact of such a decision at inference time. In contrast, an embodiment of the present disclosure embraces larger batch sizes in the streaming setting and investigate an efficient way of scheduling such stochastic workloads on NPUs under tight latency budgets.

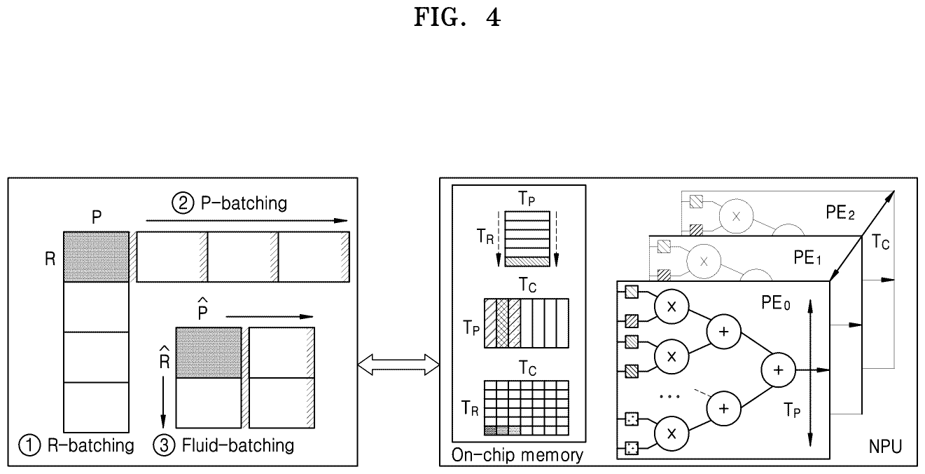

General matrix multiply (GEMM) comprises the most widely optimised computational kernel that lies at the heart of most NPU accelerators due to its ability to support both the convolutional (CONV) and fully-connected (FC) layers of CNNs, as well as the various matrix multiplications of Transformer models. An embodiment of the present disclosure considers a generic NPU design that represents a large portion of actual deployed NPUs, where each layer's input feature maps, weights and output feature maps are formed into R×P, P×C and R×C Toeplitz matrices respectively, that are stored in the off-chip memory. The execution of each layer is then reduced to a tiled GEMM operation, as depicted in FIG. 2. FIG. 2 is a schematic diagram showing the computation of a convolutional layer, mapped as GEMM. Typically, tile sizes across each dimension (T_{R}, T_{P}, T_{C}) are tightly coupled with architectural characteristics of the accelerator (concerning both the computation element and on-chip memory structure) and tuned based on the target workload through design space exploration (DSE). In this work, the adopted NPU consists of T_{C} processing elements (PEs), each comprising a Multiply-Accumulate (MAC) tree of width T_{P} (see FIG. 4). Parameter T_{R} controls the pipeline depth, while on-chip memory buffers matching the input, weight and output tile dimensionalities and allowing for double buffering are instantiated.

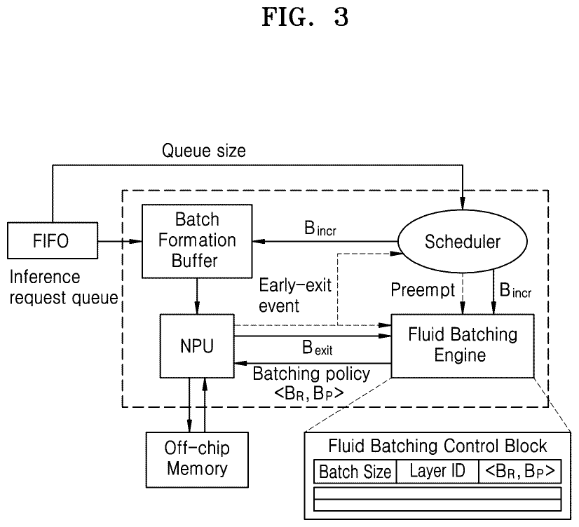

FIG. 3 is a schematic diagram according to an embodiment of the present disclosure. Inference requests associated with a common model are coming into a queue to be processed by a multi-exit model resident on the NPU. A scheduler, running on CPU, reads from the queue, forms a batch into a buffer and submits inference jobs to the NPU. Upon meeting a pre-emption point, i.e. an intermediate classifier where some of the samples are expected to exit early, an early-exit event is triggered and the number of exiting samples, Bexit, is communicated to the scheduler. At this point, the scheduler selectively pre-empts execution and a new batch of size Biner is formed and dispatched to run until the previous pre-emption point. Subsequently, the halted and the new batch are merged and execution is resumed, benefitting from the higher efficiency of the increased batch size, until the next exit is met. The whole process is orchestrated by the scheduler and a Fluid Batching Engine which tailor the adaptable batching and processing components of the NPU based on the current batch size, the model at hand, the latency SLO and the arrival rate of the incoming samples, aiming to maximise efficiency.

Edge NPU design with fluid batching. Under the GEMM formulation, existing systems typically realise batching of B samples by appending activation matrices uniformly along the row dimension for all layers, so that \hat{R}=R·B, allowing for better reuse of the weight matrix. FIG. 4 shows an input matrix formation with different batching strategies (here B=4). This has been proven particularly effective in counteracting the low computation-to-communication ratio of the memory-bound fully-connected layers, where R=1 when batching is not used. Adopting the same approach in convolutional layers, across either the R (1) or P (2) dimension to facilitate further parallelism between the samples of a batch, has also shown considerable performance gains. Nonetheless, in all cases, batching and parallelism are statically applied across all layers, whereas NPUs are typically optimised for a fixed batch size. FIG. 1 (b) is a graph showing achieved throughput with different batching strategies. Specifically, FIG. 1 (b) shows achieved throughput on ZC706 for ResNet-50 backbone (partitioned in 4 subnets of equivalent workload) with different static batching strategies adopted by the NPU (B=8). Dashed line denotes peak platform performance. Evidently, different parts of the model benefit the most from different batching implementations, as shallow and deep layers demonstrate fundamental variability in matrix dimensionalities, leading to distinct mapping inefficiencies.

Flexible Batch Processing Mechanism. In order to remedy the inefficient mapping of static batching approaches, “Fluid Batching” generalise existing strategies by dynamically selecting the breakdown of samples that are appended in each matrix dimension (R, P), based on the running layer 1 and the active batch size B_{act}. As such the NPU is able to exploit parallelism across different samples of a batch (previously being pipelined), in cases where other parallelism dimensions lead to an inefficient mapping on the available resources. In practice, Fluid Batching is realised by modifying the Direct Memory Access (DMA) to the off-chip memory, to affect the Toeplitz matrix formation process for each batch. Formally:

$${\hat{R}}^{( l )} = {B}_{R}^{( l , {B}_{act} )} \cdot {R}^{( l )} and \qquad ( 1 )$$

$${\hat{P}}^{( l )} = ( {B}_{act} - {B}_{R}^{( l , {B}_{act}} 1 ) \cdot ( {P}^{( l )} + {P}^{( l )} \% {T}_{P} )$$

where B_{R}=f(1,B_{act})∈[1, Bₘₐₓ] is provided by the Fluid Batching engine (described below) that controls the batching strategy for each layer at run time through a fine-grained mechanism, aiming to improve efficiency by eliminating resource underutilisation; and % denotes the modulo operation, used to add zero “guard” elements across the P dimension (FIG. 4) to prevent interference between different samples of the batch. As also illustrated in FIG. 4, R- and P-batching form special cases of Fluid Batching (3) for B_{R}=B_{act} and 1, respectively, along with other hybrid schemes. Notably, through DMA handling, the result of Fluid Batching's computation remains a B_{act}·R×C matrix, as in the case of R-batching, and facilitates the adoption of a different batching scheme at the subsequent layers.

Design Space Exploration (DSE). In this context, the conventional DSE mechanism for edge NPUs is enhanced in a two-fold manner. First, the attainable performance of each candidate design point is considered across different batch sizes, effectively co-optimising the hardware architecture for various batching scenarios. Second, for each visited NPU design point d=<T_{R}, T_{P}, T_{C}>, the design space of Fluid Batching is exposed to the optimisation, leading to <d, B_{R}>. Parameter B_{R}∈[1,Bₘₐₓ]^{L×B}^{ₘₐₓ} holds the Fluid Batching configuration for each layer and batch size, and is used to populate the Fluid Batching Engine (FIG. 3). Hence, DSE is case as a formal optimisation problem:

$$〈 {d}^{*} , {B}_{R} 〉 = {arg max}_{d} {\underbrace{{\sum }_{b = 1}^{{B}_{max}} {w}_{b}}}_{for each batch size} {max}_{k , {B}_{R}} T ( 〈 d , {B}_{R} 〉 , W , b ) \qquad ( 2 )$$

where w_{b} is used to control the contribution of each batch size. The performance, T(·), is estimated in GOp/s of each examined design point on a given workload W with a combination of analytical and roofline modelling. Finally, the highest performing design is obtained through exhaustive search.

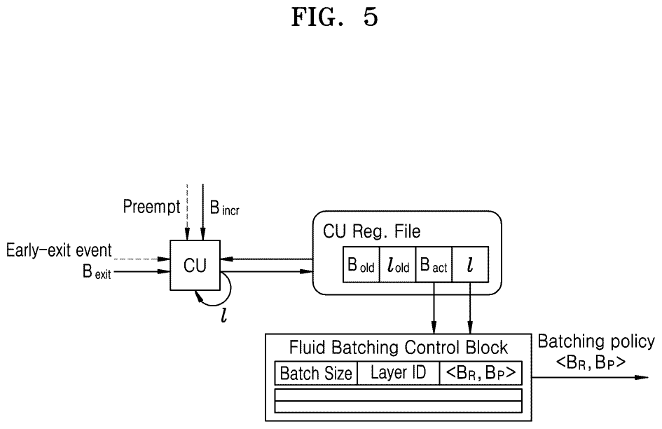

Microarchitecture. FIG. 5 shows a hardware design of the Fluid Batching Engine, comprising the Fluid Batching Control Block (FBCB) and a Control Unit (CU). The FBCB constitutes a look-up table that stores the highest performing batching policy <BR, BP> for each layer of the given DNN and for different batch sizes. As such, the FBCB contains L×Bₘₐₓ entries. Only BR is stored, while BP is derived as Bact−BP. With BR bounded by Bₘₐₓ, each layer's BR entry is represented with [log₂(Bₘₐₓ)] bits.

The CU uses Bexit and Bincr (§ 0.2) to keep track of the active batch size (Bact). When a new layer is to be processed, the CU uses Bact and the layer index 1 to address the FBCB and fetch the correct batching policy. Finally, the batching policy is used to configure the NPU's DMA controllers. This affects how the NPU reads and writes the input and output activation matrices from and to the off-chip memory.

Exit-Aware Pre-emptive Scheduler for Early-Exit DNNs. Conventional inference systems utilise the same batch size for the whole DNN. In particular, once a batch of inputs has been dispatched to the accelerator, future arriving samples have to wait until the processing of the whole batch has completed. The limitations of this approach become especially evident when processing early-exit DNNs, where the active batch size can change dynamically through the depth of the network. In this case, the status-quo model-level batching constrains the DNN to execute until the end with a reduced batch size, even if it severely underutilises the accelerator's resources.

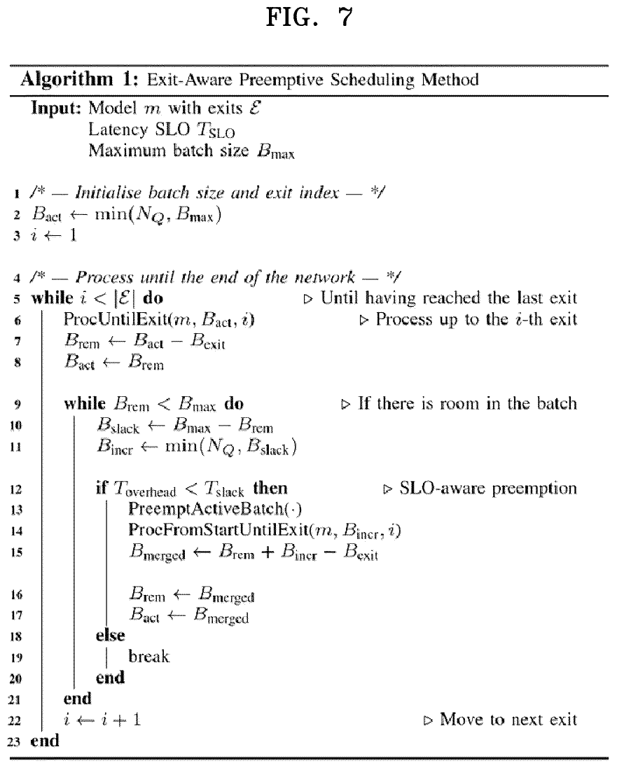

The present disclosure proposes an exit-aware preemptive scheduler that considers both the active batch size and the SLO to balance latency, throughput and SLO satisfaction. In contrast to existing systems, a scheduling granularity is introduced at the subnet level, with boundaries at the intermediate exits. As such, the already running active batch can be preempted and new samples can be processed in an interleaved manner. Concretely, the scheduler selectively preempts execution at the exit points and dispatches a new batch so that it can catch up. Next, the new samples are merged with the preempted samples to form a larger batch and resume execution with increased hardware utilisation. Formally, this policy is parameterised as <Bmax, TSLO>, where TSLO is the latency SLO. The present scheduler launches execution as soon as the first sample enters the request queue (FIG. 3). FIG. 7 shows Algorithm 1, which details the present scheduling method and is explained in detail below.

Preemptible Points. Given an L-layer DNN with a set of early exits ε, the present scheduler allows for preemption only at the early-exit points i∈ε. This design decision is based on two key insights. First, preemption is beneficial only when there are dynamic changes in the batch size and hence evaluating the preemption criterion elsewhere leads to redundant computation. Second, treating every layer as preemptible would introduce prohibitively high overhead; the scheduler would be invoked too regularly, inducing excessive computations and interruption of the NPU's operation; e.g. the present approach yields 16.6× fewer scheduler invocations for a 4-exit ResNet-50 compared to LazyBatching's layerwise approach.

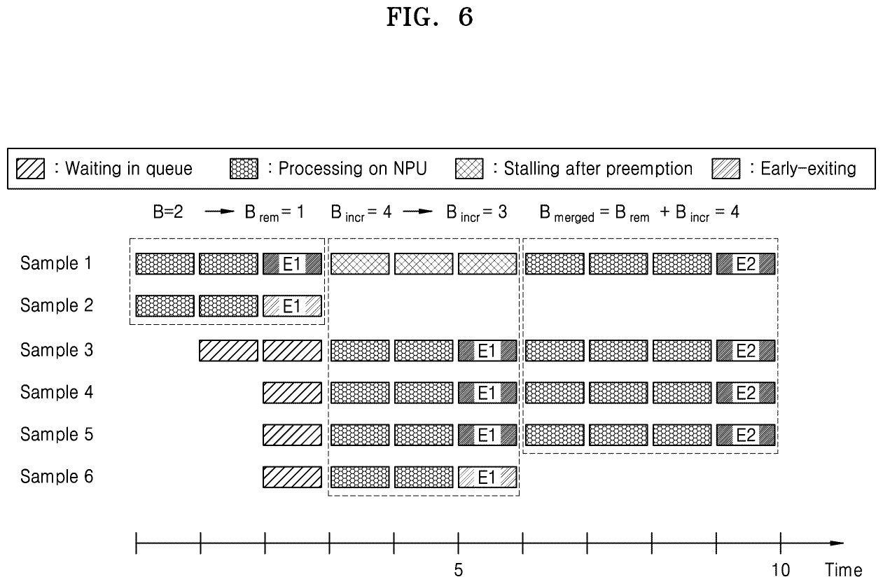

Preemption Mechanism. FIG. 6 illustrates the operation of the present scheduler. Specifically, FIG. 6 shows a scheduling timeline for a 2-exit (E1, E2) DNN with Bmax=8. After reaching E1, sample 2 exits early. The scheduler evaluates the SLO-aware preemption criterion and issues a preemption with Bincr=3. Sample 1 is preempted and samples 3 to 6 are processed up to E1. Sample 6 exits early. The scheduler determines that further preemptions would introduce SLO violations and merges the remaining samples, leading to a batch size of 4 up to exit E2.

Upon preemption at exit i, the intermediate results of the remaining active batch of size Brem=Bact−Bexit are written back to the off-chip memory (line 7 in Algorithm 1) and a new batch of samples is issued (lines 9-11). The new batch size is determined as Bincr might have been reduced as some samples might have exited at the earlier exits. Batch backfilling is accomplished per exit and non-recursively, i.e. no nested preemption for intermediate exits. This allows for having bounded stalling time for the preempted samples while maximising hardware utilisation. Finally, the rest of the DNN is executed with a merged batch size of Bmerged=Brem+Bincr (line 17 in Algorithm 1), until the next preemption point (line 6 in Algorithm 1).

Preemption Criterion. A service-level objective, SLO, aware (SLO-aware) preemption criterion is introduced that aims to minimise SLO violations. As a first step, the scheduler estimates the remaining time Tslack until the latency SLO is reached for the oldest sample in the active batch:

$${T}_{slack} = {T}_{SLO} - ( {T}_{w a i t} + {T}_{e x e c}^{so - far} ) \qquad ( 3 )$$

where T_{slack} is the queue waiting time of the oldest sample in the active batch and T_{exec}^{so-far} is the execution time passed until the preemption point was reached. The final criterion (line 12 in Algorithm 1) is:

$${T}_{overhead} < {T}_{slack} with {T}_{overhead} = {T}_{0 , i}^{{B}_{incr}} + {T}_{i + 1 : L - 1}^{{B}_{mergra}} \qquad ( 4 )$$

where T_{i:j}^{B} is the execution time from exit i to j (inclusive) with batch size B, capturing the time for the new batch to reach the i-th exit and for the merged batch to complete the inference. As Bᵢₙₑᵣ might become smaller due to its own early-exiting samples, the actual latency can be smaller and hence this approach can lead to a slight overestimation of the overhead. Nonetheless, it constitutes an upper bound and hence prevents the scheduler from introducing additional SLO violations.

Exit-Level Latency Prediction. Leveraging the deterministic dataflows of modern NPUs, a performance model was developed to estimate the per-exit latency. Alternatively, if the NPU architecture is unknown, the average per-exit latency can be profiled. At design time, the per-exit latency is measured by varying the batch size from 1 to Bₘₐₓ and the results are recorded. Upon deployment, the scheduler loads the results in a Nₑₓᵢₜₛ×Bₘₐₓ look-up table and uses it at run time to evaluate the preemption criterion and guide preemption decisions.

As the present disclosure targets a streaming setting, the present scheduler picks B_{incr} samples from the top of the queue when forming new batches, so the scheduling complexity is O(1). Samples can terminate out-of-order, with the reordering happening afterwards using the sample ID. The required input/output buffers in the off-chip memory are allocated upon initialisation to be large enough to accommodate the largest activation matrix for Bₘₐₓ, hence avoiding run-time memory management and the associated latency. Finally, as active batches are pre-empted at the end of an exit's last layer's execution, the output activations are already stored in the off-chip memory, avoiding the need for explicit checkpointing operations. The main overhead is that the memory transfer of the new input samples is not overlapped with computation. However, empirical evaluations showed that this contributed at most 0.05% in latency across instances.

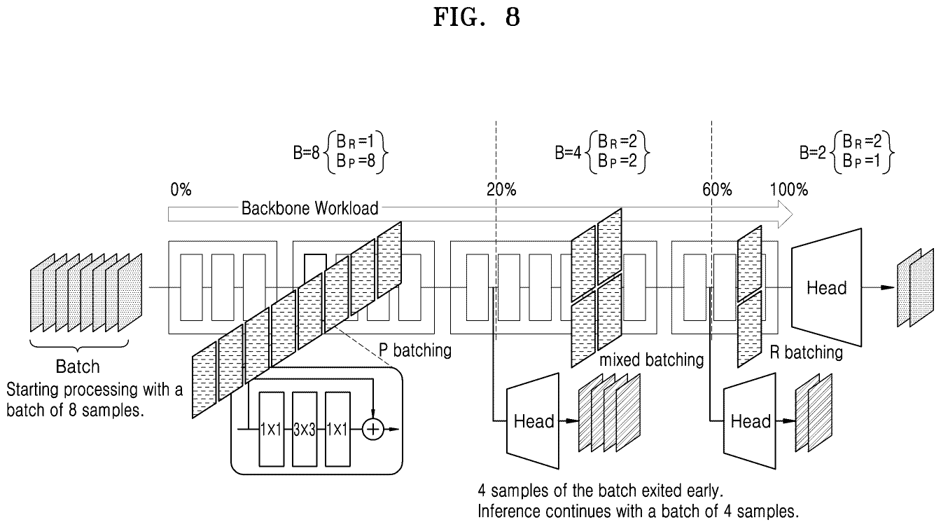

FIG. 8 is a schematic diagram of the fluid batching approach according to an embodiment of the present disclosure. Based on i) the available batch size and ii) the characteristics of each layer, the batching strategy is adapted at run time to maximise hardware utilisation. Batched samples in each layer can be appended across: i) the row (R), ii) column (P) or iii) a combination of the above dimensions, of the feature-map matrix in order to facilitate better weight re-use and hardware utilisation.

### Evaluation:

Setup. The present disclosure targets Xilinx ZC706 hosting the mid-range Z7045 FPGA and Xilinx ZCU104 with the larger ZUJEV. All hardware designs were developed in Vivado HLS and clocked at 150 and 200 MHz for ZC706 and ZCU104, respectively. All designs were synthesised and placed-and-routed using Vivado Design Suite (v2019.2) and run on both boards. The Arm CPU was used to set up the AXI interfaces to the off-chip memory and run the present scheduler. Performance was measured via hardware counters and used 16-bit fixed-point across all experiments.

Benchmarks. Evaluation was on two mainstream DNNs: ResNet-50 and Inception-v3, which constitute widely used backbones across multiple downstream vision tasks. In the multi-exit setup, the design methodology of state-of-the-art hardware-aware early-exit models was adopted (Laskaridis et al). The examined instances comprise three intermediate exits, placed equidistantly in terms of FLOPs on the corresponding frozen ImageNet-pretrained backbone. Similarly to relevant literature, softmax top-1 is employed as a metric for confidence, and the exit policy is tuned to minimise the workload while maintaining accuracy within 1.5 percentage points from the original backbone. This optimisation led to a uniform confidence threshold of 0.8 across exits, yielding exit rates of <5.1%, 16.9%, 9.0%, 69.0%,> and <14.5%, 18.6%, 22.2%, 44.7%>, and accuracies of 75.6% and 75.8%, for ResNet-50 and Inception-v3.

NPU DSE and Resource Usage. Table 1 shows the designs generated by the present DSE method (with w_{b}=1), together with their resource consumption. In addition to the processing engine, the Fluid Batching Engine's CU requires less than 0.5% of LUTs. The FBCB consumes 0.57% and 0.54% of registers on ZC706 and ZCU104, while the larger FCBC of the deeper Inception-v3 uses 0.95% and 0.90%.

TABLE 1

| | | Design Point | Resource Utilisation |
|---|---|---|---|
| Model | Platform | <TR, TP, TC> | [DSPs, BRAM, LUTs] |
| ResNet-50 | ZC706 | <4652, 7, 128> | [99.56, 99.96, 71.5]% |
| | ZCU104 | <6832, 10, 172> | [99.53, 99.99, 72.5]% |
| Inception-v3 | ZC706 | <2742, 4, 225> | [100.0, 99.94, 69]% |
| | ZCU104 | <6832, 10, 172> | [100.0, 99.99, 73]% |

### Design Points and Resource Consumption

Baselines. An embodiment of the present disclosure is compared against state-of-the-art (SOTA) batching approaches: i) single-sample execution (SERIAL), ii) FC-only batching (FC-AdaptB), iii) R dim. batching (R-AdaptB), and iv) LazyBatching. Baselines ii) and iii) correspond to SOTA adaptive batching (AdaptB) systems. Given the resource constraints of the target edge-grade platforms and DNN workloads, to support latency SLOs that make the system deployable, it is necessary to limit batch size to 8. Indicatively, executing ResNet-50 on ZCU104 with B=16 yields an average latency of 277 ms that exceeds the 200-ms SLO examined below. As such, Bₘₐₓ=8 is used across all baselines. For FC and R, AdaptB's Tₜᵢₘₑₒᵤₜ parameter is set to three different values: small(S), medium (M) and large (L) corresponding to a batch-forming waiting time equal to 5%, 45% and 95% of the 99th percentile latency SLO. For the SLO-aware LazyBatching, its scheduler is configured with the respective SLO in each experiment. For each baseline, design space exploration (DSE) is performed using a batch size of 8 and select the highest performing NPU design for the target DNN-device pair.

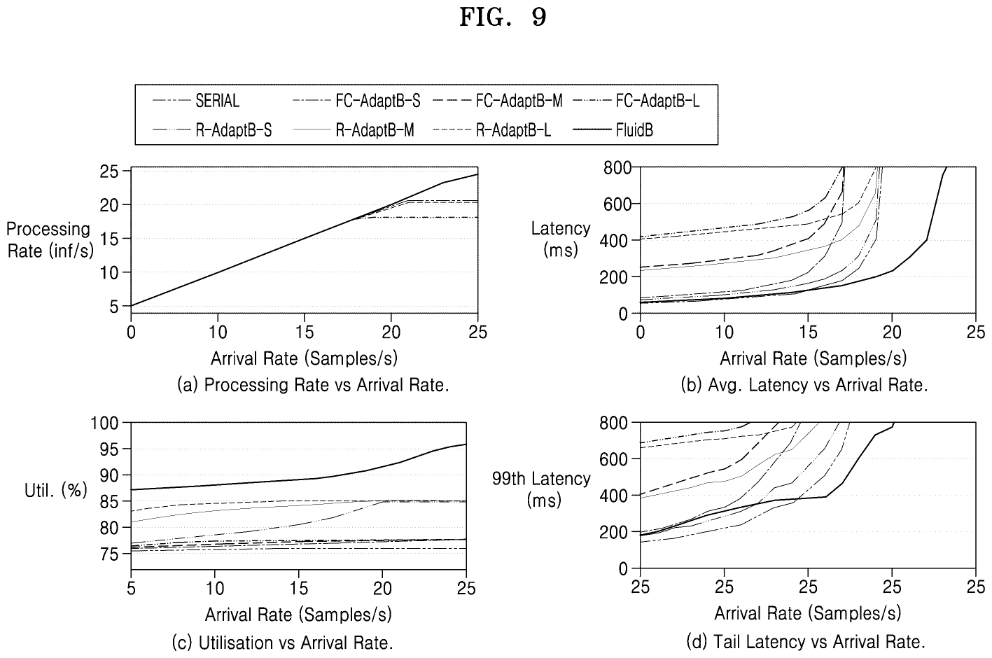

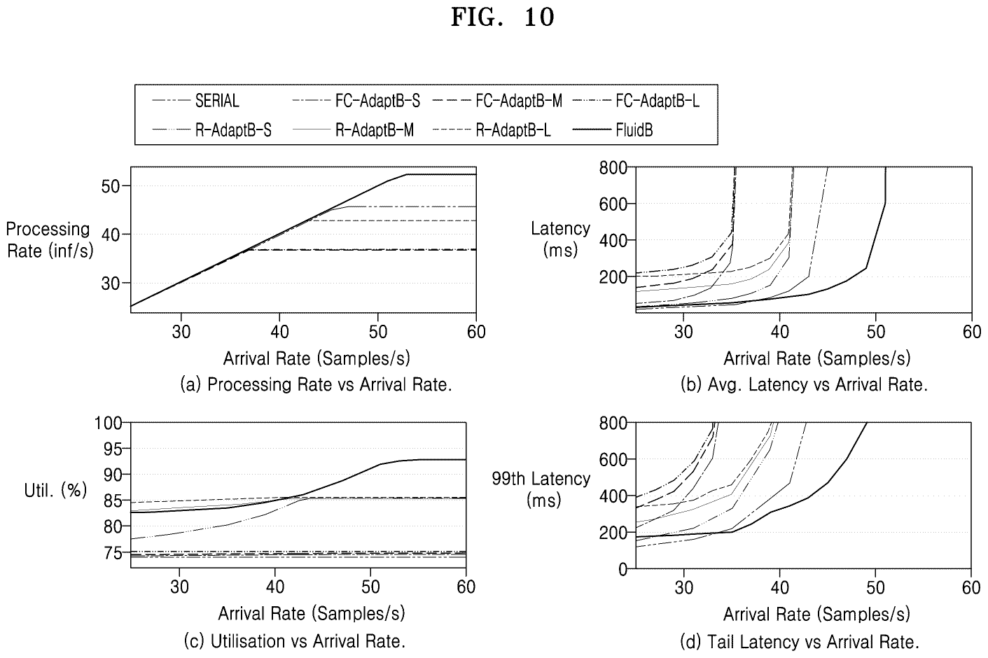

Performance Comparison. FIGS. 9 and 10 show results of experiments to evaluate performance according to an embodiment of the present disclosure. To evaluate the performance and adaptability of the present approach across traffic levels, the request arrival rate is varied between 5 and 25 samples/s and 20 and 60 samples/s for ResNet-50 (FIG. 9, (a) to (d)) and Inception-v3 (FIG. 10, (a) to (d)), respectively. Following the MLPerf standard, the arrival times of the input samples were generated following a Poisson distribution, with an expected rate equal to the specified samples/s. The 99th percentile latency SLO was set to 400 ms for ZC706 and to 200 ms for ZCU104. All experiments were run three times with different seeds and the average is reported.

Low-to-mid traffic: For slow-arriving samples, the large waiting windows of AdaptB-M and -L lead to excessive latency for batch forming, despite the higher utilisation due to large-batch processing. The small waiting windows of AdaptB-S, on the other hand, provide a better balance between utilisation and latency. SERIAL yields the lowest latency, but also the lowest utilisation. In contrast, the present approach (FluidB) combines the merits of both approaches; it provides the user with SERIAL's QoE by meeting the SLO and achieving similar average latency, but also yields significantly higher utilisation (20.4% average gain across the range 5 to 18 samples/s on ZC706 and 13.5% average gain across the range 25 to 35 samples/s on ZCU104), by means of the flexible opportunistic batching of its scheduler.

Mid-to-high traffic: For higher traffic, FC reaches a plateau in processing rate as it solely enables FC layers to benefit from batching. Similarly, R reaches its limit, because batching uniformly only along the R dimension cannot extract any additional performance. At the same time, all FC and R variants gradually lead to excessive average and tail latency and constant utilisation. This can be attributed to the impact of early-exiting on batch size and the model-level batching of these approaches; as samples exit early, the effective batch size through the DNN is dynamically decreased. As FC and R variants are not exit-aware and do not allow preemptions, they execute the rest of the DNN with smaller batch size and hence lower utilisation. This leaves input samples unnecessarily waiting in the queue, despite the extra batch room in the system.

Instead, FluidB exploits this extra room through its exit-aware scheduler that selectively preempts execution and merges new samples to form larger batches, thus processing the rest of the DNN with higher utilisation, while also benefiting from the enhanced mapping efficiency of all layers to the NPU. In addition, as the scheduler considers the SLO when making decisions, the average and tail latency are also kept under control. In particular, in traffic levels where there is enough slack from the SLO to perform a preemption, e.g. between 5 and 15 samples/s in FIG. 9D, the scheduler trades off a slightly higher tail latency-still without introducing violations—for a 20% increase in NPU utilisation. Above 15 samples/s, FluidB provides significant gains in both average and tail latency, even over SERIAL. This can be attributed to the fact that under high traffic, incoming samples experience large waiting times. FluidB is able to better fill any space in the active batch through its flexible batching. As such, it cuts the waiting time and boosts the utilisation of the NPU, reaching close to 95% for high traffic, far exceeding all alternatives. Finally, it sustains higher processing rate than other approaches, with above 20 and 55 inf/s on ZC706 and ZCU104, respectively.

Comparison to LazyBatching. Table 2 shows a comparison with LazyBatching as measured on ZC706 and ZCU104, with stringent tail latency SLOs and mid-to-high arrival rates. Targeting ResNet-50, the present system achieves 1.43× and 2.5× lower average latency (1.89× geo. mean) while providing a significant SLO violation reduction of 13.2 percentage points (pp) and 27.1 pp (20.15 pp avg.), respectively. LazyBatching introduces three sources of latency overhead. First, as it is exit-unaware, it invokes the preemption logic on every layer. As such, the associated latency is not fully amortised, affecting the average latency. Second, when the maximum batch size is reached, preemption is no longer considered, despite the fact that samples may exit early. Third, LazyBatching adopts a coarse and conservative method of estimating the latency of preemption, i.e. instead of considering the actual latency-throughput trade-off of batched execution, it approximates batched latency as the product of batch size and single-sample latency. This leads to an overestimation of the preemption overhead, with the system often deciding not to perform a preemption, even in cases where there is enough SLO slack and room in the batch due to early exiting. The overall effect is unnecessarily higher waiting time for many samples. Instead, the present approach shows that accurately estimating the preemption overhead and incorporating exit-awareness into the scheduler are critical especially under high load and tight tail latency requirements, as they lead to well-amortised preemptions and significantly reduced SLO violations.

TABLE 2

| | | | | | | Fluid Batching | |
|---|---|---|---|---|---|---|---|
| | | | | LazyBatching | | | Viol. |
| Model | Platform | Arrival Rate | SLO | Avg. Lat. | Viol. Rate | Avg. Lat. | Rate |
| ResNet-50 | ZC706 | 15 samples/s | 200 ms | 173 ms | 23.53% | 121 ms | 10.33% |
| | ZCU104 | 40 samples/s | 100 ms | 143 ms | 35.48% | 57 ms | 8.38% |
| Inception-v3 | ZC706 | 15 samples/s | 400 ms | 287 ms | 15.94% | 213 ms | 7.93% |
| | ZCU104 | 40 samples/s | 200 ms | 216 ms | 14.20% | 97 ms | 6.21% |

Comparison with LazyBatching

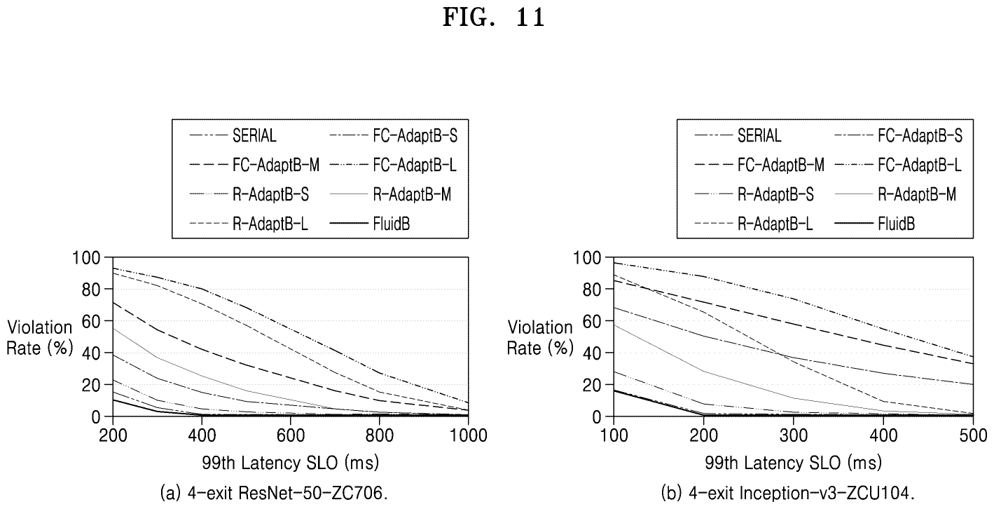

Sensitivity to SLO. FIG. 11 show results of experiments to assess robustness of an embodiment of the present disclosure to different latency SLOs. To assess robustness to different latency SLOs, the tail latency SLO is swept and the violation rate of FluidB and the alternatives is measured for the same arrival rate of 15 samples/s for ZC706 and 35 samples/s for ZCU104. As shown in FIGS. 11, AdaptB variants experience significant violations even when the SLO is relaxed, i.e. to the right of the x-axis. FluidB achieves no violations unless the SLO is set to excessively low latencies considering the workload at hand, demonstrating its effectiveness even under stringent constraints. Compared to SERIAL, FluidB provides similar or fewer violations, at the added value of substantially improved NPU utilisation.

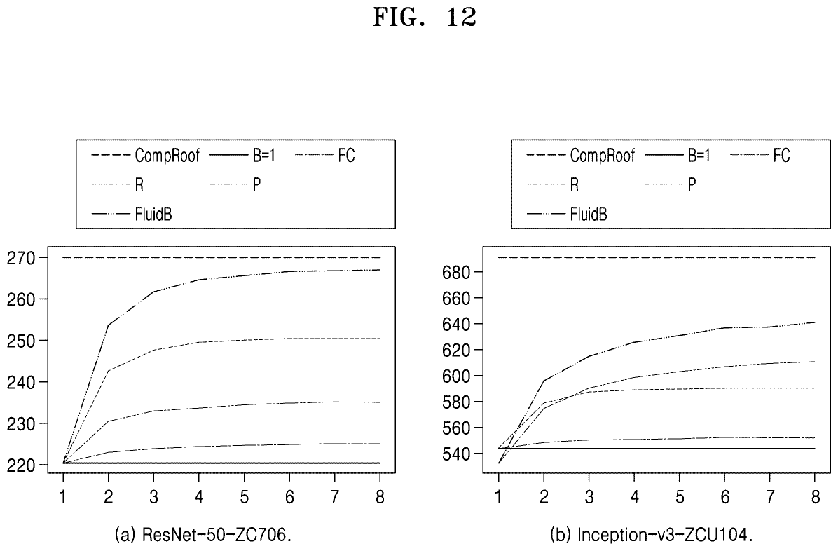

NPU Ablation. To evaluate the benefits of Fluid Batching on the NPU, several baselines are obtained by running DSE targeting the ResNet-50 and Inception-v3 backbones without early exits, considering multiple uniform batching strategies across layers and a static batch size during inference. FIG. 12 shows the performance of the resulting designs across batch sizes. It is observed that Fluid Batching converges to significantly higher performance than all alternatives, even approaching the theoretical peak of the device in the case of ResNet-50 for S>3.

Although the evaluation includes two diverse processing platforms and a broad range of request traffic and latency constraints, the performance of the proposed system is mainly evaluated on convolutional neural networks. As early-exit mechanisms are being increasingly integrated into emerging Transformer architectures, an investigation on the applicability of an embodiment of the present disclosure in this family of models constitutes a natural continuation of the present work. Notably, the attention mechanism of Vision Transformers comprises a mainly compute-bound and more regular workload better fitting the GEMM structure of the examined accelerators, while demonstrating limited weight reuse between samples which leads to significantly less pronounced benefits from batching. However, exploiting different realisations of the architectural flexibility of the proposed NPU design (e.g. to dynamically trade intra- and inter-attention head parallelism at a layer granularity at run time to deal with varying input-sequence length), as well as the introduced exit-aware scheduler to make more informed preemption decisions and improve inference efficiency under such dynamic workloads, remains an open research question to be investigated in future work. Nonetheless, many Transformer architectures to date feature a mix of convolutional and attention layers mapped on the same NPU. In such cases, Fluid Batching can equip the dimensionality of convolutional layers with further flexibility, leading potentially to a more efficient mapping to the hardware accelerator.

An embodiment of the present disclosure may also introduce further flexibility by tuning of the confidence threshold—and thus the exit policy—at run time, as another means of optimising the execution under varying traffic.

An embodiment of the present disclosure may be used for edge-based settings, where the target platforms have limited computational capabilities and deployable configurations in terms of the maximum batch size supported, as well as cloud-grade setups, where batch sizes can be larger and traffic rates higher, but also offloading can be partial.

An embodiment of the present disclosure provide a framework for efficiently scheduling and serving multiple DNN inference requests of multi-exit models on edge NPUs. Despite the common belief that batch processing can be prohibitive for low-latency applications, it is shown that dynamicity-aware preemptive scheduling yields the best of both worlds; the high utilisation of batching and the low latency of single-sample execution. Moreover, through hardware support for Fluid Batching, the attainable NPU utilisation is pushed beyond what was previously possible. Last, exit-awareness and accurate latency estimation leads to well-amortised preemptions, even under high load, and significantly fewer SLO violations.

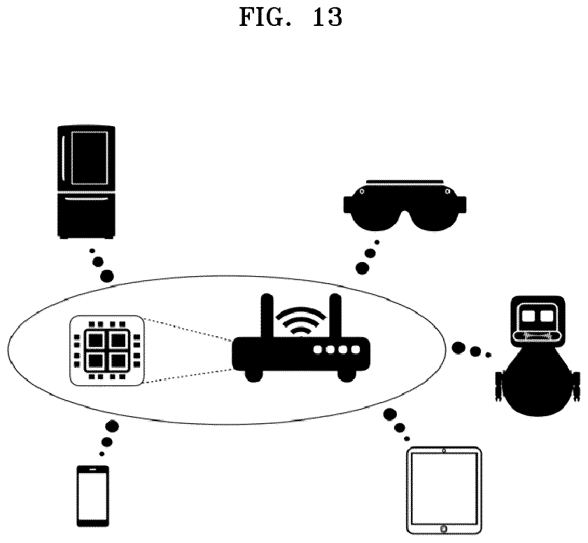

FIG. 13 is a diagram illustrating an example use according to an embodiment of the present disclosure. Nowadays, there are multiple workloads using the same backbone DNNs inside a house, spanning different users and different tasks. An NPU-based design serving multiple workloads using Fluid Batching can help increase the throughput of such workloads. Use-case examples include: Image classification in galleries of users' phones; Person identification from multiple in-house security cameras (e.g. doorbell and dome camera); and automatic speech recognition, ASR, from multiple smart speakers.

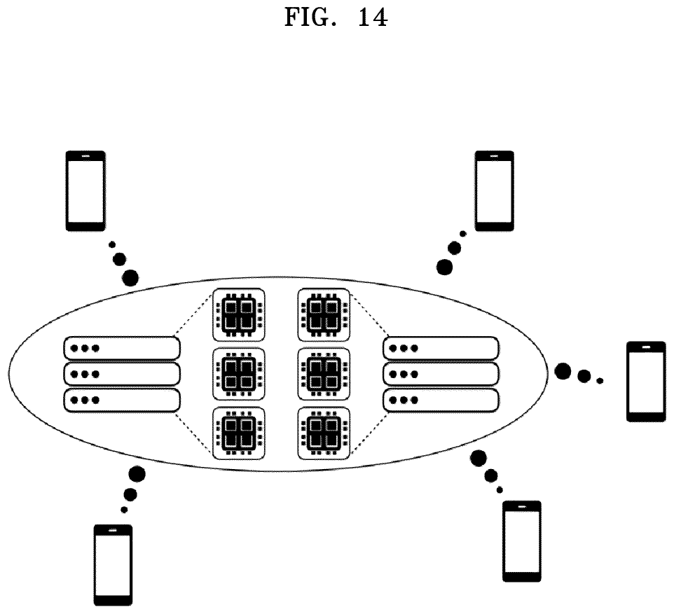

FIG. 14 is a diagram illustrating an example use according to an embodiment of the present disclosure. Inference serving can often be offloaded to the cloud. Such workloads are highly repetitive, but coupled with early-exit workloads, they may not be predictable. An embodiment of the present disclosure can boost the efficiency and throughput of cloud solutions to serving more inference requests per second with fewer SLO violations on average.

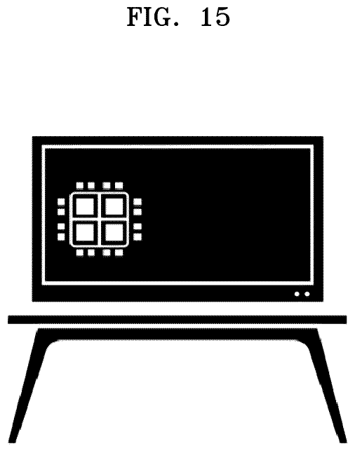

FIG. 15 is a diagram illustrating an example use according to an embodiment of the present disclosure. Devices do not necessarily have to offload computation to remote more powerful devices. Instead, they can integrate NPUs, capable of near-sensor computation, without the latency penalties of round-trip communication. This can be applicable to cases where several frames are combined for a task, such as: TV content for scene optimisation/recommender systems and/or mapping a home/industrial setting with robotic agents/VR headsets.

An embodiment of the present disclosure has the potential to improve the utilisation of the NPU's computational resources and sustain higher throughput than the state-of-the-art systems under the same stringent latency constraints. Increased NPU utilisation impacts the cost of several parties. Service providers (SPs) such as cloud-based AI platforms save cost by performing the necessary computations faster, hence using the NPU for less time and reducing cost of occupying a cloud instance. Moreover, the improved throughput under latency constraints enables the SPs to scale up their service to a larger user base, by being able to serve more users (higher throughput) without penalising the quality of service (low latency/fast response time). Users in smart home environments save energy bills cost by performing the offloaded DNN computations with higher energy efficiency, as a direct impact of an embodiment of the present disclosure higher utilisation of the NPU. Similarly, mobile device users and embedded systems are benefited with prolonged battery life, higher throughput that allows the processing of high-volume streams of data, and lower latency which ensures fast response time for both user-facing apps and mobile robots.

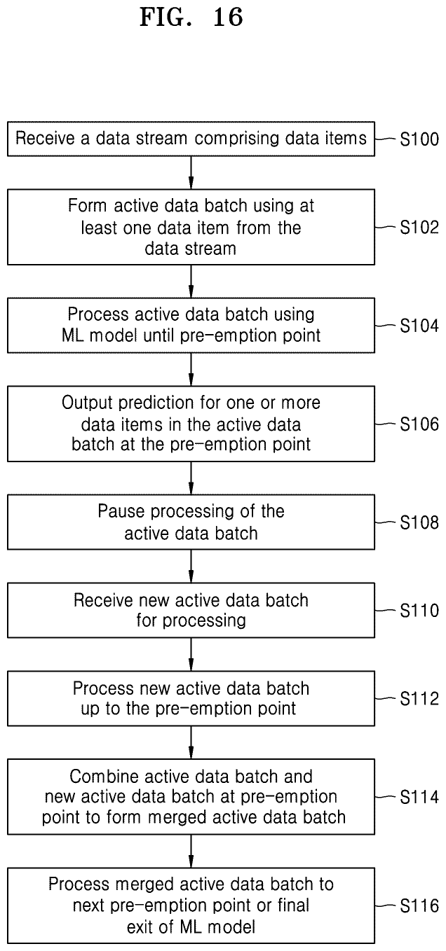

FIG. 16 is a flowchart of example steps of a method for processing data using a multi-exit machine learning model having a plurality of neural network layers, a plurality of early exits and a final exit to provide predictions. The method comprises: receiving a data stream, the data stream comprising a plurality of data items to be processed by the multi-exit ML model (step S100); forming an active data batch for processing by the multi-exit ML model, using at least one data item from the plurality of data items in the data stream (step S102); processing the active data batch using the multi-exit ML model until a pre-emption point, the pre-emption point being an early exit of the plurality of early exits (step S104); outputting a prediction for one or more data items in the active data batch at the pre-emption point (step S106); pausing processing of the active data batch and transmitting, to the scheduler, information about the one or more data items in the active data batch for which a prediction has been output from the pre-emption point (step S108); by the scheduler, determining, using information about the one or more data items in the active data batch for which a prediction has been output from the pre-emption point, a new active data batch for processing up until the pre-emption point, the new active data batch containing at least one data item from the data stream that is different to the at least one data item in the active data batch and receiving the new active data batch via the scheduler (step S110); processing the new active data batch using the multi-exit ML model until the pre-emption point (step S112); combining, when the pre-emption point is reached, the active data batch with the new active data batch to form a merged active data batch (step S114); and processing the merged active data batch using the multi-exit ML model until a subsequent pre-emption point or to the final exit of the multi-exit ML model (step S116). Steps of the method may be performed using software or hardware, or a combination of software and hardware.

As mentioned above, at step S100, the data items for processing by the multi-exit ML model are received in a data stream, which is used to form a queue of inference requests for the model. Thus, data items are used to form the active data batch based on their order in the queue. However, predictions for data items may not necessarily be output from the ML model in the same queue order, because predictions for data items may be output at early exits.

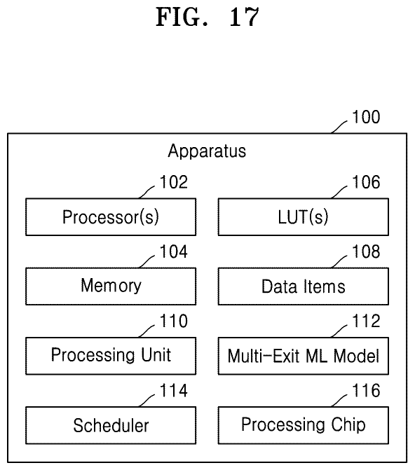

FIG. 17 is a block diagram of an apparatus 100 for processing data using a multi-exit machine learning model 112 having a plurality of neural network layers, and a plurality of early exits and a final exit to provide predictions. The apparatus 100 comprises: at least one processor 102 coupled to memory 104. The at least one processor 102 may comprise one or more of: a microprocessor, a microcontroller, and an integrated circuit. The at least one processor 102 may be a CPU. The memory 104 may comprise volatile memory, such as random access memory (RAM), for use as temporary memory, and/or non-volatile memory such as Flash, read only memory (ROM), or electrically erasable programmable ROM (EEPROM), for storing data, programs, or instructions, for example.

The at least one processor may be configured for: receiving a data stream, the data stream comprising a plurality of data items 108 to be processed by the multi-exit ML model 112; and forming, using a scheduler 114, an active data batch for processing by the multi-exit ML model 112, using at least one data item from the plurality of data items 108 in the data stream.

The apparatus 100 comprises a scheduler 114. The scheduler 114 may be implemented as software. In this case, the scheduler may be an algorithm executed by the at least one processor (e.g. a CPU). Alternatively, the scheduler 114 may be implemented as hardware. In this case, the apparatus may comprise a processing chip 116, and the scheduler is a module on the processing chip. The processing chip 116 may comprise other modules, such as, for example, the proposed Fluid Batching Control Block and off-chip memory described in more detail below with respect to FIG. 3. The at least one processor 102 (e.g. CPU) may form the active data batch by instructing the hardware or software scheduler 114 to do so.

The apparatus 100 comprises a processing unit, PU, 110 for executing the multi-exit ML model 112 by: receiving, from the at least one processor 102, the active data batch for processing by the multi-exit ML model; processing the active data batch until a pre-emption point, the pre-emption point being an early exit of the plurality of early exits; outputting a prediction for one or more data items in the active data batch at the pre-emption point; pausing processing of the active data batch; transmitting, to the scheduler, information about the one or more data items in the active data batch for which a prediction has been output from the pre-emption point; receiving, via the scheduler, a new active data batch for processing up until the pre-emption point, the new active data batch containing at least one data item from the data stream that is different to the at least one data item in the active data batch; processing the new active data batch until the pre-emption point; combining the active data batch with the new active data batch to form a merged active data batch; and processing the merged active data batch until a subsequent pre-emption point or to the final exit of the multi-exit ML model.

The apparatus 100 may comprise one or more look-up tables, LUTs, 106 storing an optimum batching configuration for each layer of the multi-exit ML model as a function of the determined size of the active data batch.

Those skilled in the art will appreciate that while the foregoing has described what is considered to be the best mode and where appropriate other modes of performing the embodiments, the embodiments should not be limited to the specific configurations and methods disclosed in this description of the preferred embodiment. Those skilled in the art will recognise that the embodiments have a broad range of applications, and that the embodiments may take a wide range of modifications without departing from any inventive concept as defined in the appended claims.

What is claimed is:

1. An apparatus for processing data using a multi-exit machine learning (ML) model having a plurality of neural network layers, and a plurality of early exits and a final exit to provide predictions, the apparatus comprising:
at least one processor coupled to memory, for:
receiving a data stream, the data stream comprising a plurality of data items; and
forming, using a scheduler, an active data batch for processing by the multi-exit ML model, using at least one data item from the plurality of data items in the data stream; and
a processing unit, PU, for executing the multi-exit ML model by:
receiving, from the at least one processor, the active data batch;
processing the active data batch until a pre-emption point, the pre-emption point being an early exit of the plurality of early exits;
outputting a prediction for one or more data items in the active data batch at the pre-emption point;
pausing processing of the active data batch;
transmitting, to the scheduler, information about the one or more data items in the active data batch for which a prediction has been output from the pre-emption point;
receiving, via the scheduler, a new active data batch for processing up until the pre-emption point, the new active data batch containing at least one data item from the data stream that is different to the at least one data item in the active data batch;
processing the new active data batch until the pre-emption point;
combining the active data batch with the new active data batch to form a merged active data batch; and
processing the merged active data batch until a subsequent pre-emption point or to the final exit of the multi-exit ML model.

2. The apparatus as claimed in claim 1, wherein the scheduler forms the active data batch by:
selecting at least one data item from the data stream to form the active data batch, based on an order of the data items in the data stream and a maximum active batch size.

3. The apparatus as claimed in claim 2, wherein the scheduler determines the maximum active batch size using a latency constraint.

4. The apparatus as claimed in claim 2, wherein the scheduler determines the maximum active batch size using a processing capability of the processing unit (PU).

5. The apparatus as claimed in any of claim 2, further comprising a batching engine for controlling the processing unit (PU) wherein the batching engine is configured to:
determine the size of the active data batch;
obtain, from a look-up table, an optimum batching configuration for each layer of the multi-exit ML model as a function of the determined size of the active data batch; and
instruct, prior to processing by a layer of the multi-exit ML model, the processing unit, PU, to assemble the selected at least one data item using the obtained optimum batching configuration for the layer.

6. The apparatus as claimed in claim 5, wherein the active data batch is a matrix having a number of rows and a number of columns, and wherein the processing unit, PU, is configured to:
receive the instructions from the batching engine; and
assemble, prior to processing by a layer of the multi-exit ML model, the selected at least one data item in the active data batch using the obtained optimum batching configuration for the layer by:
assembling the selected at least one data item along one or more rows, or
assembling the selected at least one data item along one or more columns, or
assembling the selected at least one data item across at least one row and at least one column.

7. The apparatus as claimed in claim 5, wherein the batching engine comprises:
a control block comprising the look-up table; and
a control unit for:
tracking the determined active data batch size,
determining which layer of the multi-exit ML model is to be used next to process the active data batch,
using the determined active data batch size and determined layer of the multi-exit ML model to obtain the optimum batching configuration for the determined layer, and
instructing the processing unit, PU, to assemble the active data batch using the optimum batching configuration for the determined layer.

8. The apparatus as claimed in any of claim 1, wherein when the processing unit pauses processing of the active data batch, the processing unit is arranged to:
write, to an off-chip memory, an intermediate processing result for any remaining data items in the active data batch.

9. The apparatus as claimed in claim 8, wherein, prior to processing by a layer of the multi-exit ML model, the processing unit is configured to combine the active data batch with the new active data batch by:
reading the intermediate processing result from the off-chip memory; and
merging the read intermediate processing result with a new intermediate processing result for the new active data batch.

10. The apparatus as claimed in any of claim 1, wherein the multi-exit ML model comprises a pre-emption point at a plurality of the early exits of the multi-exit ML model.

11. The apparatus as claimed in any of claim 1, wherein the at least one processor is configured to:
receive, from the processing unit, information about the one or more data items in the active data batch for which a prediction has been output from the pre-emption point;
calculate, using the scheduler, a size of any data items remaining in the active data batch for which no prediction has been output; and
determine, using the calculated size and the scheduler, a size for the new active data batch.

12. The apparatus as claimed in claim 11, wherein the at least one processor is configured to:
estimate, using the scheduler, a completion time for processing an oldest data item of the data items remaining in the active data batch for which no prediction has been output, the completion time including an elapsed time taken to reach the pre-emption point.

13. The apparatus as claimed in claim 12, wherein the at least one processor is configured to:
determine, using the scheduler, whether the estimated completion time for processing the oldest data item in the active data batch is less than a predefined latency constraint; and
form, using the scheduler and the determined size for the new active data batch, the new active data batch using one or more data items from the data stream, when the estimated completion time is determined to be less than the predefined latency constraint.

14. The apparatus as claimed in claim 12, wherein the at least one processor is configured to:
determines, using the scheduler, whether the estimated completion time for processing the oldest data item in the active data batch is less than a predefined latency constraint; and
instructs the processing unit, PU, to continue processing the active data batch when the estimated completion time is determined to be greater than or equal to the predefined latency constraint.

15. A method for processing data using a multi-exit machine learning (ML) model having a plurality of neural network layers, and a plurality of early exits and a final exit to provide predictions, the method comprising:
receiving a data stream, the data stream comprising a plurality of data items; and
forming an active data batch for processing by the multi-exit ML model, using at least one data item from the plurality of data items in the data stream;
processing the active data batch using the multi-exit ML model until a pre-emption point, the pre-emption point being an early exit of the plurality of early exits;
outputting a prediction for one or more data items in the active data batch at the pre-emption point;
pausing processing of the active data batch;
determining, using information about the one or more data items in the active data batch for which a prediction has been output from the pre-emption point, a new active data batch for processing up until the pre-emption point, the new active data batch containing at least one data item from the data stream that is different to the at least one data item in the active data batch;
processing the new active data batch using the multi-exit ML model until the pre-emption point;
combining, when the pre-emption point is reached, the active data batch with the new active data batch to form a merged active data batch; and
processing the merged active data batch using the multi-exit ML model until a subsequent pre-emption point or to the final exit of the multi-exit ML model.

16. The method as claimed in claim 15, further comprising:
selecting at least one data item from the data stream to form the active data batch, based on an order of the data items in the data stream and a maximum active batch size.

17. The method as claimed in claim 16, further comprising:
determining the maximum active batch size using a latency constraint and/or a processing capability of a processing unit, PU, used to execute the multi-exit ML model.

18. The method as claimed in claim 17, further comprising:
determining the size of the active data batch;
obtaining, from a look-up table, an optimum batching configuration for each layer of the multi-exit ML model as a function of the determined size of the active data batch; and
assembling, prior to processing by a layer of the multi-exit ML model, the selected at least one data item using the obtained optimum batching configuration for the layer.

19. The method as claimed in any of claim 15, wherein when processing of the active data batch is paused, the method comprises:
writing, to an off-chip memory, an intermediate processing result for any remaining data items in the active data batch.

20. A non-transitory computer-readable storage medium comprising instructions which, when executed by a processor, causes the processor to carry out a method for processing data using a multi-exit machine learning (ML) model having a plurality of neural network layers, and a plurality of early exits and a final exit to provide predictions, the method comprising:
receiving a data stream, the data stream comprising a plurality of data items;
forming an active data batch for processing by the multi-exit ML model, using at least one data item from the plurality of data items in the data stream;
processing the active data batch using the multi-exit ML model until a pre-emption point, the pre-emption point being an early exit of the plurality of early exits;
outputting a prediction for one or more data items in the active data batch at the pre-emption point;
pausing processing of the active data batch;
determining, using information about the one or more data items in the active data batch for which a prediction has been output from the pre-emption point, a new active data batch for processing up until the pre-emption point, the new active data batch containing at least one data item from the data stream that is different to the at least one data item in the active data batch;
processing the new active data batch using the multi-exit ML model until the pre-emption point;
combining, when the pre-emption point is reached, the active data batch with the new active data batch to form a merged active data batch; and
processing the merged active data batch using the multi-exit ML model until a subsequent pre-emption point or to the final exit of the multi-exit ML model.
